(19) United States
(12) Patent Application Publication
(10) Pub. No.: US 2025/0360583 A1
(43) Pub. Date: Nov. 27, 2025

(54) MOBILE TOOL-SUPPORT APPARATUS

(71) Applicant: The Boeing Company, Arlington, VA (US)

(72) Inventor: Chester James Hill, IV, Grafton, IL (US)

(21) Appl. No.: 18/670,282

(22) Filed: May 21, 2024

(51) Int. Cl. B23P 23/02

(52) U.S. Cl. CPC B23P 23/02

(57) ABSTRACT

An example tool-support apparatus includes a frame having a first support member, a second support member, a third support member, and a fourth support member; a first host-mating plate affixed to the first support member; a second host-mating plate affixed to the second support member; a first stabilizer affixed to the third support member; a second stabilizer affixed to the fourth support member; a first rail extending between the first support member and the third support member; a second rail extending between the second support member and the fourth support member; and a tool support member having a first end slidably coupled to the first rail and having a second end slidably coupled to the second rail.

### FIELD OF THE DISCLOSURE

This disclosure relates generally to manufacturing and, more particularly, to mobile tool-support apparatus.

### BACKGROUND

Manufacturing environments include a wide variety of machines and work assemblies to produce different items. Machines and work assemblies are stationed at respective locations within their manufacturing environments.

### BRIEF DESCRIPTION OF THE DRAWINGS

FIG. 1 is a perspective view of an example mobile tool-support apparatus.

FIG. 2 is a side view of the example mobile tool-support apparatus of FIG. 1.

FIG. 3 is a front view of the example mobile tool-support apparatus of FIGS. 1 and 2.

FIG. 4 is an example host-mounted configuration of the mobile tool-support apparatus of FIGS. 1-3.

FIG. 5 is an example tool-mounted configuration of the mobile tool-support apparatus of FIGS. 1-3.

FIG. 6 is a side view of another example mobile tool-support apparatus having an alternative host-mating configuration.

FIG. 7 is a front view of the example mobile tool-support apparatus of FIG. 6.

FIG. 8 is an underside view showing host-mating anchors of the example mobile tool-support apparatus of FIGS. 6-7 disengaged from anchor receiver structures of a host assembly.

FIG. 9 is the underside view of FIG. 8 showing the host-mating anchors of the example mobile tool-support apparatus of FIGS. 6-7 engaged with the anchor receiver structures of the host assembly.

In general, the same reference numbers will be used throughout the drawings and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Examples disclosed herein may be used to implement mobile tool-support apparatus that removably couple to assembly jigs in a manufacturing environment. Example mobile tool-support apparatus disclosed herein enable supplemental tools to provide location-independent and precision-based manufacturing support. For example, mobile tool-support apparatus disclosed herein enable such supplemental tools to be transported to different locations of a manufacturing environment and precision-set to different-assembly jigs (e.g., host assemblies) to provide precision assembly operations.

To enable precision-setting and removably coupling to assembly jigs, mobile tool-support apparatus disclosed herein provide locator pins (e.g., precision indexes) to be coordinated and aligned to alignment reference structures (e.g., laser tracker cubes) on the assembly jigs. In this manner, the example mobile tool-support apparatus result in prosthetic tooling and operate as precision jig adapters. That is, tooling can be made prosthetic to assembly jigs in a manufacturing environment by using the example mobile tool-support apparatus disclosed herein to adaptively couple the tooling to and decouple the tooling from the assembly jigs.

Example mobile tool-support apparatus disclosed herein implement repeatable platforms that include stabilizers (e.g., collet-based locking mechanisms, collar-based shaft-locking mechanisms, and/or other shaft-locking or attachment mechanisms) to support a cantilevered end on any surface. As used herein, a repeatable platform refers to the characteristic of a mobile tool-support apparatus to perform a same operation or motion repeatedly while consistently reaching the same physical location within acceptable manufacturing tolerances throughout the multiple iterations of that operation or motion. This increases the usability and manufacturing quality that can be achieved with transportable assembly tooling when applied to precision assembly tooling (e.g., full-size determinant assembly (FSDA) tooling or any other type of assembly tooling). Accordingly, uses of example mobile tool-support apparatus disclosed herein result in no distortion in tool positioning and maintain precision indexing and rail coordination to alignment reference structures on assembly jigs.

Example mobile tool-support apparatus disclosed herein support use of non-monolithic tooling and multiple types of manufacturing/assembly tools with precision. Examples disclosed herein provide production/manufacturing versatility, decreased manufacturing time, reduction in tool complexity, and enhanced tool user experience. Examples disclosed herein reduce tooling footprints and overall tool size and enable manufacturing tools to be placed at on-demand assembly locations in a manufacturing environment. As such, examples disclosed herein reduce manufacturing costs by re-using the same tool with multiple assembly jigs, thereby reducing or eliminating redundancies in tools. For example, a single tool can be flexibly moved to multiple tooling locations using the example mobile tool-support apparatus disclosed herein so that the same tool can be used with multiple assembly jigs in a manufacturing environment.

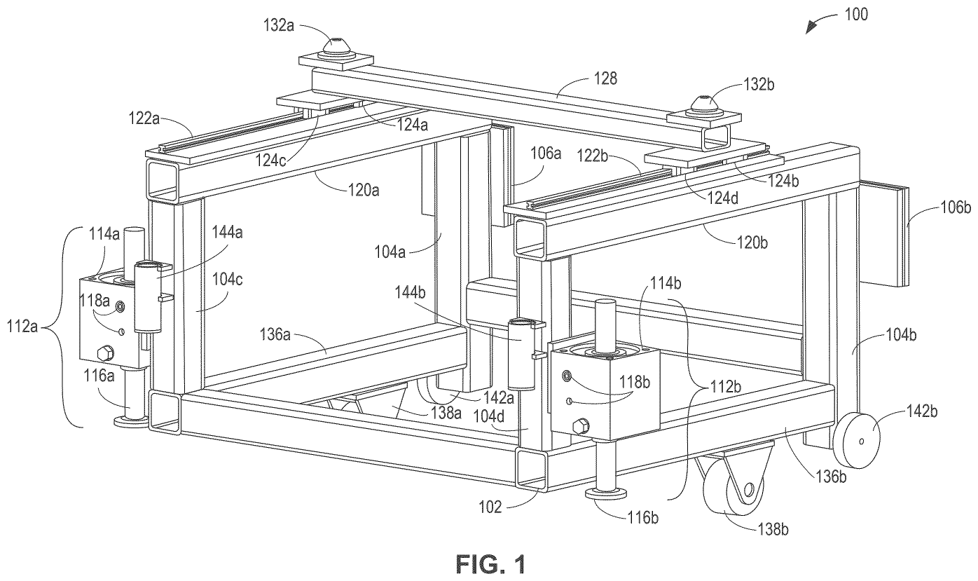

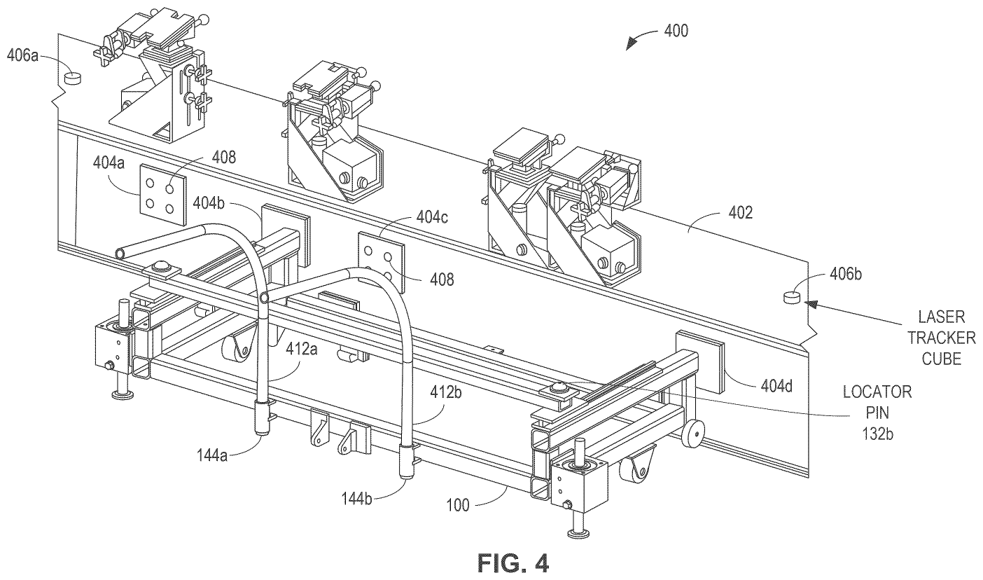

FIG. 1 is a perspective view of an example mobile tool-support apparatus 100. The mobile tool-support apparatus 100 is useable as a prosthetic to an assembly jig (e.g., a host assembly 402 of FIG. 4) by being removably coupled to the assembly jig as a cantilevered supplement to achieve a particular manufacturing operation using a tool that is removably attached to the mobile tool-support apparatus 100.

The mobile tool-support apparatus 100 includes an example frame 102. The frame 102 includes an example first support member 104a, an example second support member 104b, an example third support member 104c, and an example fourth support member 104d. In example FIG. 1, the first support member 104a and the second support member 104b are located at a front side of the mobile tool-support apparatus 100 to provide support for vertical forces. As such, the first support member 104a and the second support member 104b are front vertical support members 104a,b. Also in example FIG. 1, the third support member 104c and the fourth support member 104d are located at a rear side of the mobile tool-support apparatus 100 to provide support for vertical forces. As such, the third support member 104c and the fourth support member 104d are rear vertical support members 104c,d.

In example FIG. 1, the support members 104a-d are implemented using elongated metal stock material (e.g., steel tubing, cold rolled steel, steel flat bar stock, aluminum, etc.). However, in other examples, the frame 102 may be implemented using other types of materials or structures in addition to or instead of the elongated metal stock material. For example, the frame 102 may additionally or alternatively be implemented using sheet metal components attached along the edges of the sheet metal to form the structure of the frame 102.

The mobile tool-support apparatus 100 includes a first host interface 106a affixed or coupled to the first support member 104a and a second host interface 106b affixed or coupled to the second support member 104b. For example, the first and second host interfaces 106a,b can be welded, fastened, or coupled any other way to the first and second support members 104a,b. In example FIG. 1, the first host interface 106a and the second host interface 106b are located at the front side of the mobile tool-support apparatus 100 to removably couple the frame 102 to a host assembly (e.g., the host assembly 402 of FIG. 4) in a manufacturing environment. For example, in FIG. 1, the first and second host interfaces 106a,b are host-mating plates that are to engage receiving pads (e.g., the receiving pads 404a-c of FIG. 4) of a host assembly (e.g., the host assembly 402) as described below in connection with FIG. 4.

The mobile tool-support apparatus 100 includes an example first stabilizer 112a affixed or coupled (e.g., welded, fastened, clamped, etc.) to a first portion of the frame 102 to the third support member 104c and an example second stabilizer 112b affixed or coupled (e.g., welded, fastened, clamped, etc.) to a second portion of the frame 102 opposite the first portion. In example FIG. 1, the first stabilizer 112a is affixed or coupled to the third support member 104c and the second stabilizer 112b affixed or coupled to the fourth support member 104d. Alternatively, the stabilizers 112a,b may be affixed or coupled to any other suitable portions of the frame 102.

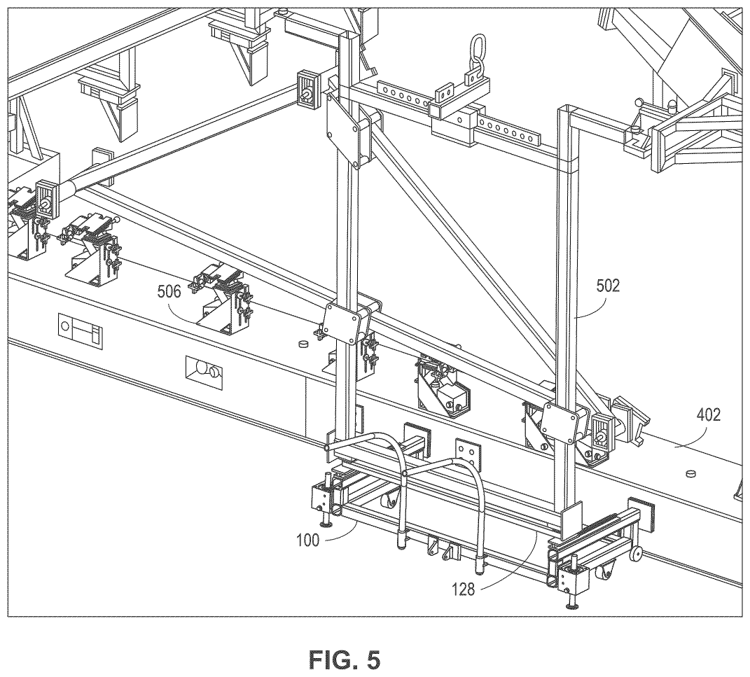

The first and second stabilizers 112a,b are non-load inducing, non-deformation causing locking mechanisms that support the frame 102 to any flooring condition and provide a repeatable platform to support multiple tooling items (e.g., a tool 502 described below in connection with FIG. 5). The first and second stabilizers 112a,b may be implemented using collet-based locking mechanisms, collar-based shaft-locking mechanisms, and/or other shaft-locking or attachment mechanisms. In example FIG. 1, the first stabilizer 112a includes an example first collet assembly 114a and an example first elongated member 116a (e.g., an adjustable support leg or adjustable support column) retractably extendable through the first collet assembly 114a towards a surface (e.g., a floor) supporting the mobile tool-support apparatus 100. Also in example FIG. 1, the second stabilizer 112b includes an example second collet assembly 114b and an example second elongated member 116b (e.g., an adjustable support leg or adjustable support column) retractably extendable through the second collet assembly 114b towards the surface (e.g., a floor) supporting the mobile tool-support apparatus 100. The elongated members 116a,b may be implemented using steel tubing, cold rolled steel, steel flat bar stock, aluminum, etc.

In example FIG. 1, the first and second collet assemblies 114a,b can be mechanically or pneumatically actuated to lock and release the first and second elongated members 116a,b. For example, lock and release controls 118a,b on corresponding ones of the first and second collet assemblies 114a,b can be manipulated or adjusted to air lock/release or mechanically lock/release the first and second elongated members 116a,b to move towards and away from a floor (e.g., a surface supporting the mobile tool-support apparatus 100). Although the illustrated example of FIG. 1 includes the first and second collet assemblies 114a,b as collet-based locking mechanisms, the first and second stabilizers 112a,b may alternatively be implemented using any other type of shaft-locking mechanisms including collar-based shaft-locking mechanisms. For example, collar-based shaft-locking mechanisms use a housed shaft collar to securely lock corresponding retractably-extendable shafts in place based on friction-locking. The friction-locked shafts provide stability to the mobile tool-support apparatus 100 on different flooring conditions.

In example FIG. 1, the stabilizers 112a,b do not introduce upward force on the mobile tool-support apparatus 100. To prevent such upward force, the mechanical or pneumatic lock and release controls 118a,b release the elongated members 116a,b from retracted positions. Upon release, the elongated members 116a,b drop by gravity towards the floor supporting the mobile tool-support apparatus 100. This dropping of the elongated members 116a,b is based on gravity so that additional downward force is not exerted on the elongated members 116a,b. By relying on gravity in this manner, the elongated members 116a,b do not create an upward force on the mobile tool-support apparatus 100. After the elongated members 116a,b engage the floor, the lock and release controls 118a,b can be manipulated or adjusted to air lock or mechanically lock the first and second elongated members 116a,b in place to provide weight-bearing support to the mobile tool-support apparatus 100.

Since the first and second collet assemblies 114a,b are affixed or coupled to the frame 102, the first and second elongated members 116a,b provide weight-bearing support for items, such as tools, placed on the frame 102. The first and second elongated members 116a,b are configured to move independently from one another through their respective ones of the first and second collet assemblies 114a,b. This accounts for unlevel surfaces (e.g., unlevel floors) on which the mobile tool-support apparatus 100 could be located. For example, such independent movement of the elongated members 116a,b provides strong support and stabilization for the frame 102 across a range of flat, non-flat, uneven, and unlevel surfaces (e.g., different flooring conditions) on which the frame 102 may be located. When under load and stabilized by the first and second collet assemblies 114a,b, the structural members of the frame 102 provide a non-deforming support and repeatable platform for such tools.

Although only two stabilizers 112a,b are shown, the mobile tool-support apparatus 100 could be adapted to have any other number of stabilizers 112a,b. For example, more stabilizers 112a,b may be affixed or coupled to other locations of the frame 102 to support heavier tool applications. In some examples, any number of the stabilizers 112a,b may be temporarily coupled to the frame 102 so that more stabilizers 112a,b could be added when heavier tools are mounted to the mobile tool-support apparatus 100 and stabilizers 112a,b can be removed for lighter tool use.

The mobile tool-support apparatus 100 includes an example first top crossbar 120a and an example second top crossbar 120b. The first top crossbar 120a extends between the first support member 104a at the front side of the frame 102 and the third support member 104c at the rear side of the frame 102. The second top crossbar 120b extends between the second support member 104b at the front side of the frame 102 and the fourth support member 104d at the rear side of the frame 102. The first and second top crossbars 120a,b may be implemented using elongated metal stock material (e.g., steel tubing, cold rolled steel, steel flat bar stock, aluminum, etc.).

The mobile tool-support apparatus 100 includes an example first rail 122a (e.g., a linear rail) and an example second rail 122b (e.g., a linear rail). For example, the first rail 122a extends between the first support member 104a and the third support member 104c, and the second rail 122b extends between the second support member 104b and the fourth support member 104d. In example FIG. 1, the first rail 122a is mounted to the first top crossbar 120a so that the first rail 122a is located along a length of the first top crossbar 120a. In addition, the second rail 122b is mounted to the second top crossbar 120b so that the second rail 122b is located along a length of the second top crossbar 120b.

The mobile tool-support apparatus 100 includes an example first carriage 124a (e.g., a carriage block) and an example third carriage 124c slidably coupled to the first rail 122a. The mobile tool-support apparatus 100 includes also includes an example second carriage 124b (e.g., a carriable block) and an example fourth carriage 124d slidably coupled to the second rail 122b.

The mobile tool-support apparatus 100 includes an example tool support member 128 having a first end slidably coupled to the first rail 122a and having a second end slidably coupled to the second rail 122b. For example, the first end of the tool support member 128 is coupled to the first and third carriages 124a,c that slide along the first rail 122a, and the second end of the tool support member 128 is coupled to the second and fourth carriages 124b,d that slide along the second rail 122b. Accordingly, the rails 122a,b and the carriages 124a-d allow linear translation of the tool support member 128 along the rails 122a,b. In this manner, the tool support member 128 is to receive and support a tool (as described below in connection with FIG. 5) and facilitate slidably moving the tool along the first rail 122a and the second rail 122b towards the first and second host interfaces 106a,b at the front side of the frame 102 and away from the first and second host interfaces 106a,b. The tool support member 128 may be implemented using elongated metal stock material (e.g., steel tubing, cold rolled steel, steel flat bar stock, aluminum, etc.).

The mobile tool-support apparatus 100 includes a first locator pin 132a slidably coupled to the first rail 122a and a second locator pin 132b slidably coupled to the second rail 122b. For example, the first locator pin 132a is mounted to the first end of the tool support member 128, and the second locator pin 132b is mounted to the second end of the tool support member 128. The locator pins 132a,b are to align the mobile tool-support apparatus 100 with a host assembly as described below in connection with FIG. 4.

The mobile tool-support apparatus 100 includes an example first bottom crossbar 136a and an example second bottom crossbar 136b extending between the front and back sides of the frame 102. For example, The first bottom crossbar 136a extends between the first support member 104a at the front side of the frame 102 and the third support member 104c at the rear side of the frame 102, and the second bottom crossbar 136b extends between the second support member 104b at the front side of the frame 102 and the fourth support member 104d at the rear side of the frame 102. The first and second bottom crossbars 136a,b may be implemented using elongated metal stock material (e.g., steel tubing, cold rolled steel, steel flat bar stock, aluminum, etc.).

Example caster wheels 138a,b are located on corresponding ones of the first and second bottom crossbars 136a,b. For example, the caster wheels 138a,b may be welded, fastened, or coupled any other way to the first and second bottom crossbars 136a,b. The caster wheels 138a,b are provided to make the mobile tool-support apparatus 100 transportable between different locations (e.g., in a manufacturing environment). The mobile tool-support apparatus 100 also includes example front caster wheels 142a,b located at the front of the frame 102.

The mobile tool-support apparatus 100 includes example handle receivers 144a,b to receive removably insertable handles (e.g., handles 412a,b of FIG. 4). Such removably insertable handles allow a person to move the mobile tool-support apparatus 100 and adjust the vertical and horizontal positioning of the mobile tool-support apparatus 100 when attaching the mobile tool-support apparatus 100 to a host assembly. The handle receivers 144a,b allow the handles to be removed during operation of the mobile tool-support apparatus 100 and inserted when the mobile tool-support apparatus 100 is to be adjusted or moved to a different physical location.

The mobile tool-support apparatus 100 is not limited to the dimensional proportions shown in FIG. 1. Instead, the mobile tool-support apparatus 100 may be constructed according to different width, depth, and/or height dimensions to satisfy size, weight, use, etc. characteristics of different tools and different applications.

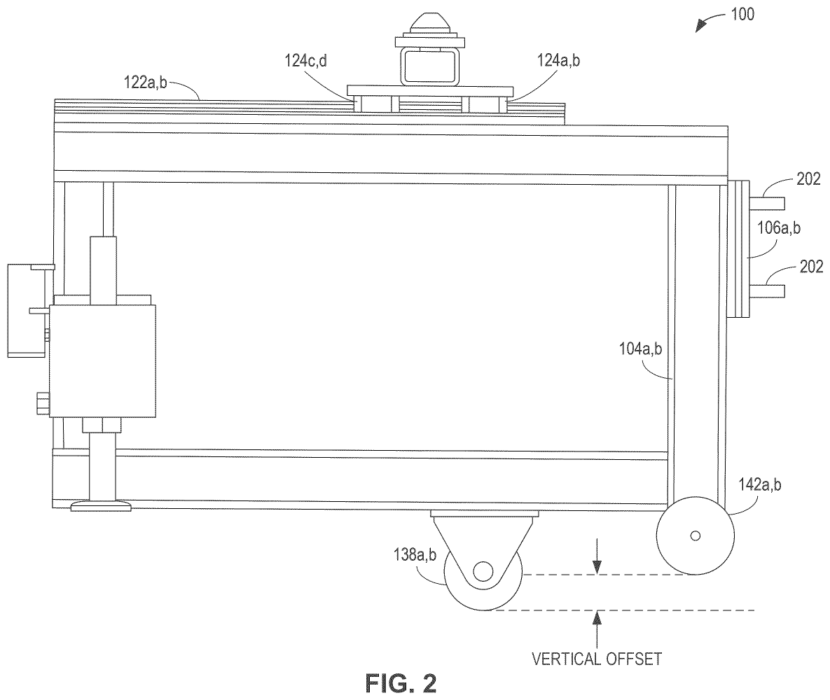

FIG. 2 is an example side view of the mobile tool-support apparatus 100 of FIG. 1. The side view of FIG. 2 shows the carriages 124a-d slidably coupled to the rails 122a,b in a manner that allows the carriages 124a-d to slidably move along corresponding ones of the rails 122a,b between the front and back sides of the frame 102. As also shown in example FIG. 2, the front caster wheels 142a,b are vertically offset relative to the caster wheels 138a,b. This vertical offset enables the front side of the frame 102 to be tilted upward and downward when positioning the mobile tool-support apparatus 100 at a host assembly (e.g., the host assembly 402 of FIG. 4). Such upward and downward adjusting of the frame 102 allows precise positioning of the mobile tool-support apparatus 100 relative to the host assembly.

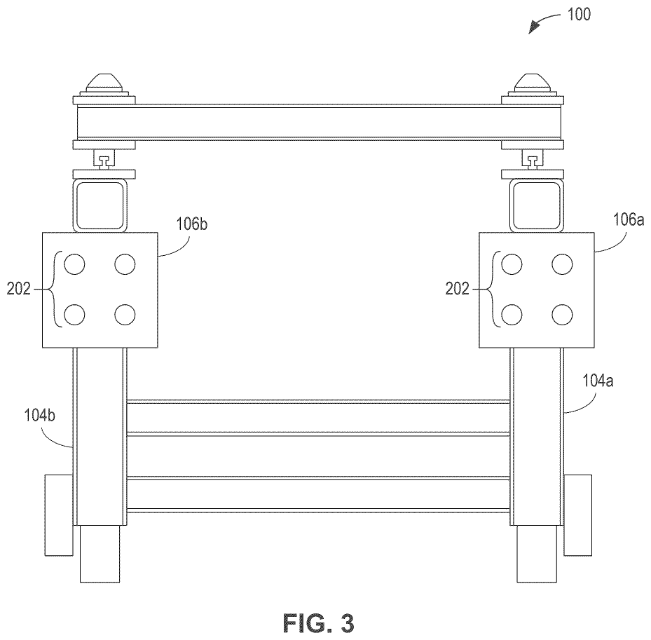

In example FIG. 2, positioning pins 202 extend from the first and second host interfaces 106a,b. The positioning pins 202 are to be received in one or more corresponding positioning aperture(s) (e.g., positioning apertures 408 of FIG. 4) of a host assembly (e.g., the host assembly 402 of FIG. 4). FIG. 3 also shows the positioning pins 202 in a front view of the host interfaces 106a,b of the example mobile tool-support apparatus 100. The pins 202 may be implemented using any metal pins or metal stock material (e.g., steel tubing, cold rolled steel, steel flat bar stock, aluminum, etc.). Alternatively, any other suitable materials may instead be used such as plastic. In addition, fewer or more positioning pins 202 may be provided.

FIG. 4 is an example host-mounted configuration of the mobile tool-support apparatus 100 of FIGS. 1-3. In example FIG. 4, an example host assembly 402 (e.g., an assembly jig) includes example receiver pads 404a-c located at different positions along a side surface of the host assembly 402. Each receiver 404a-c includes example positioning apertures 408 formed therein. The positioning apertures 408 are in the receivers 404a-c according to formations, arrangements, or placements that match the configurations of the positioning pins 202 of FIGS. 2 and 3. In this manner, when the mobile tool-support apparatus 100 is moved into engagement with the host assembly 402, the host interfaces 106a,b of the mobile tool-support apparatus 100 are moved towards ones of the receivers 404a-d of the host assembly 402 aligned with the host interfaces 106a,c. As the host interfaces 106a,c mesh with the corresponding ones of the receivers 404a-d, the positioning pins 202 of the host interfaces 106a,c are received in mating fashion in corresponding ones of the positioning apertures 408 of the corresponding receivers 404a-d. In this manner, the positioning pins 202 and the positioning apertures 408 can be used to achieve precise positioning of the mobile tool-support apparatus 100 relative to the host assembly 402 when the mobile tool-support apparatus 100 is installed for use at the host assembly 402.

In some examples, additional alignment between the mobile tool-support apparatus 100 and the host assembly 402 can be performed using example alignment reference structures 406a,b (e.g., laser tracker cubes) located at different positions along a surface of the host assembly 402. For example, the locator pins 132a,b on the tool support member 128 of the mobile tool-support apparatus 100 can be aligned with corresponding ones of the alignment reference structures 406a,b of the host assembly 402 to achieve precision alignment of the mobile tool-support apparatus 100 with a particular location of the host assembly 402.

Example FIG. 4 also shows handles 412a,b removably installed in corresponding ones of the handle receivers 144a,b. The handles 412a,b allow a person to move the mobile tool-support apparatus 100 and adjust the vertical and horizontal positioning of the mobile tool-support apparatus 100 when attaching the mobile tool-support apparatus 100 to the host assembly 402. The handle receivers 144a,b are shown at different locations of the mobile tool-support apparatus 100 in FIG. 4 relative to their locations shown in FIG. 1. The handle receivers 144a,b may be mounted at any suitable location on the frame 102 of the mobile tool-support apparatus 100 to achieve a natural handling position for a person when moving or adjusting the mobile tool-support apparatus 100.

FIG. 5 is an example tool-mounted configuration of the mobile tool-support apparatus 100 of FIGS. 1-3. In example FIG. 5, an example tool 502 is removably coupled or mounted to the first and second rails 122a,b via the tool support member 128 so that the tool 502 is movable along the first and second rails 122a,b towards and away from the host assembly 402. For example, the tool 502 can be removably coupled or mounted to the tool support member 128 using any suitable type of fastening or clamping technique.

In example FIG. 5, the tool 502 is a hoist to move objects 506 to and from the host assembly 402 or between different locations of the host assembly 402. However, any other type of tool may be coupled or mounted to the tool support member 128 for use in a manufacturing environment. For example, the mobile tool-support apparatus 100 is able to support a number of different tools for use with the host assembly 402 to establish precision presentation of items ready for assembly. Such items could be structural components for an airplane, vehicle, or any other structure. Additionally or alternatively, a tool mounted on the mobile tool-support apparatus 100 could present another tool used to implement some level of manufacturing in a manufacturing environment. As such, tools installed on the mobile tool-support apparatus 100 could be used to handle product parts for assembly or used to handle other tools.

By using the mobile tool-support apparatus 100, the tool 502 can be moved away from the host assembly 402 so that the tool 502 does not obstruct or interfere with operation of the host assembly 402 when the tool 502 is not needed. Additionally, the entire mobile tool-support apparatus 100 can be detached from the host assembly 402 so that the mobile tool-support apparatus 100 does not obstruct or interfere with operation of the host assembly 402 when the mobile tool-support apparatus 100 is not needed.

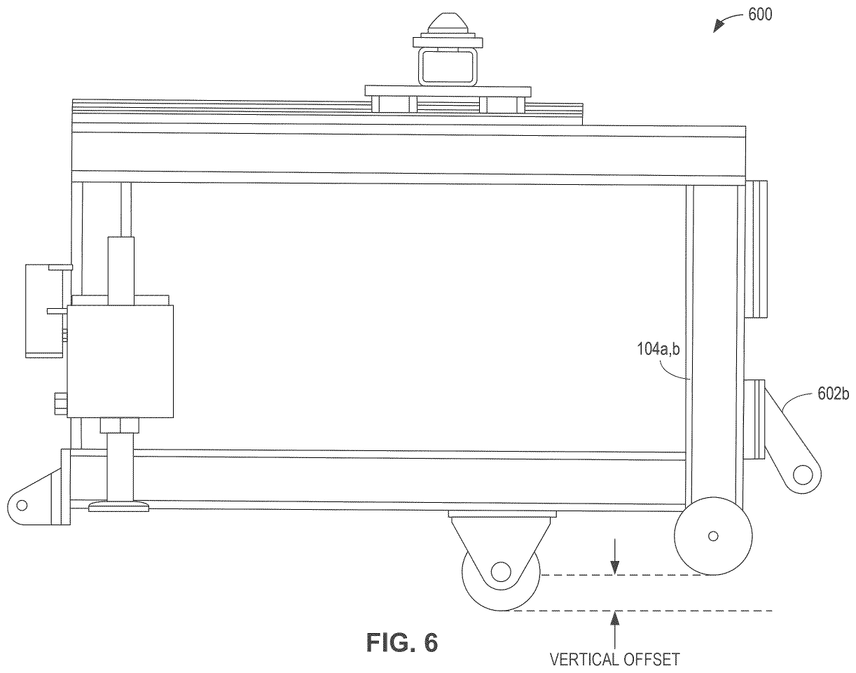

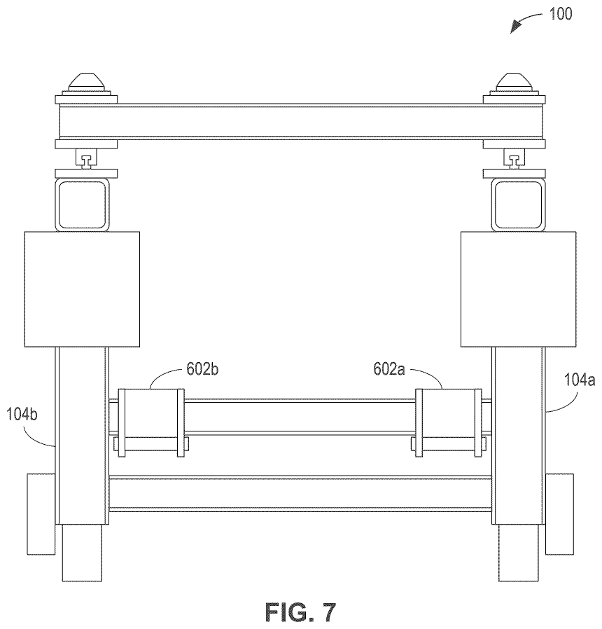

FIG. 6 is a side view of another example mobile tool-support apparatus 600 having an alternative host-mating configuration. FIG. 7 is a front view of the mobile tool-support apparatus 600 of FIG. 6. For purposes of brevity, descriptions of components of the mobile tool-support apparatus 600 that are substantially similar or identical to components of the mobile tool-support apparatus 100 of FIGS. 1-3 are not repeated. Instead, the interested reader is referred to their descriptions above.

The alternative host-mating configuration of the mobile tool-support apparatus 600 is based on host-mating anchors 602a,b affixed or coupled to the front side of the frame 102, as shown in FIGS. 6 and 7. For example, the host-mating anchors 602a,b can be welded, fastened, or coupled any other way to the first and second support members 104a,b at the front side of the frame 102.

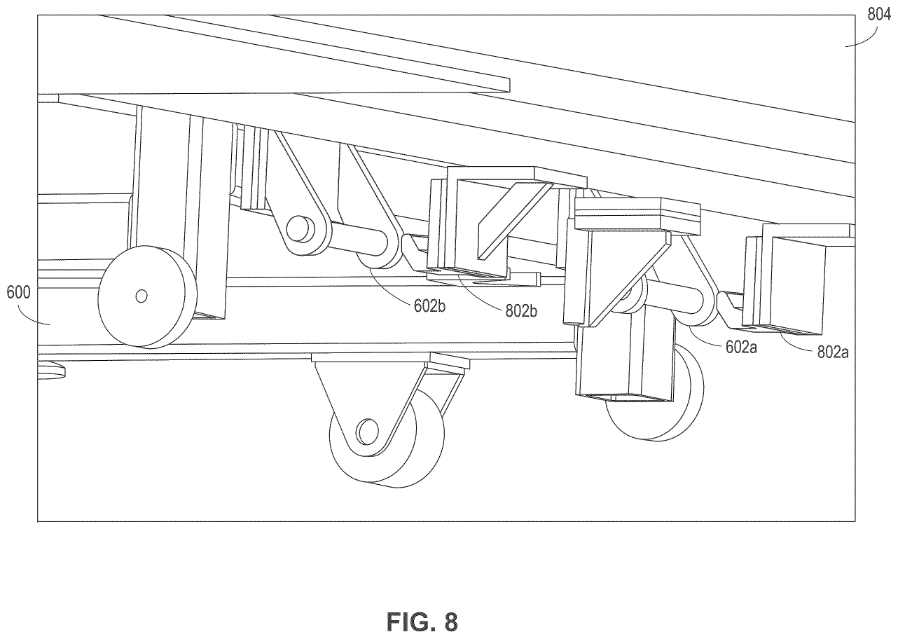

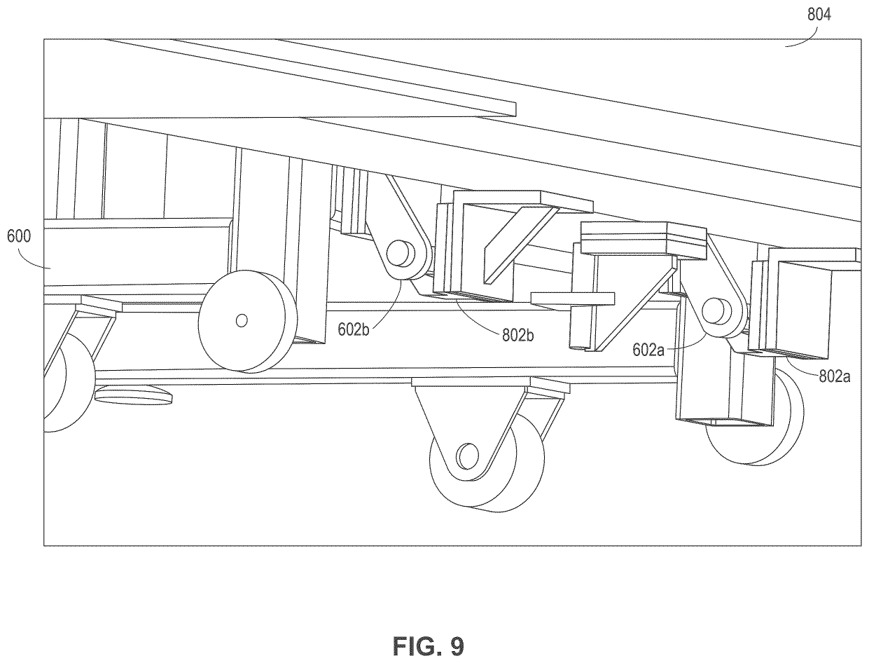

FIG. 8 is an underside view showing the host-mating anchors 602a,b of the mobile tool-support apparatus 600 of FIG. 6 disengaged from example anchor receiver structures 802a,b of an example host assembly 804. The anchor receiver structures 802a,b can be welded, fastened, or coupled any other way to a surface of the host assembly 804 that is accessibly by the host-mating anchors 602a,b of the mobile tool-support apparatus 600. In this manner, when the mobile tool-support apparatus 600 is moved into engagement with the host assembly 804, the host-mating anchors 602a,b of mobile tool-support apparatus 600 are moved towards respective ones of the anchor receiver structures 802a,b of the host assembly 804. As the host-mating anchors 602a,b mesh with their respective anchor receiver structures 802a,b, the host-mating anchors 602a,b are received in mating fashion in the anchor receiver structures 802a,b, as shown in FIG. 9. In this manner, the host-mating anchors 602a,b and the anchor receiver structures 802a,b can be used to achieve precise positioning of the mobile tool-support apparatus 600 relative to the host assembly 804 when the mobile tool-support apparatus 600 is installed for use at the host assembly 804.

Both of the mobile tool-support apparatus 100 of FIGS. 1-5 and the mobile tool-support apparatus 600 of FIGS. 1-9 are usable to support tools at different locations of a manufacturing environment. For example, techniques disclosed herein facilitate methods of re-locating a mobile tool-support apparatus 100, 600 to a location of an assembly jig (e.g., the host assemblies 402, 804) in a manufacturing environment, removably coupling the mobile tool-support apparatus 100, 600 to the assembly jig via a host interface (e.g., the host interfaces 106a,b, 602a,b) of the mobile tool-support apparatus 100, 600 and a receiver (e.g., the receivers 404a,b, 802a,b) of the assembly jig, removably coupling a tool (e.g., the tool 502) to the mobile tool-support apparatus 100, 600, and moving the tool towards and away from the assembly jig along rails (e.g., the rails 122a,b) of the mobile tool-support apparatus 100, 600.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., welded, clamped, affixed, fastened, mounted, attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

The following paragraphs provide various examples of the examples disclosed herein.
Example 1 includes a tool-support apparatus comprising a frame having a first support member, a second support member, a third support member, and a fourth support member, a first host-mating plate affixed to the first support member, a second host-mating plate affixed to the second support member, a first stabilizer affixed to the third support member, a second stabilizer affixed to the fourth support member, a first rail extending between the first support member and the third support member, a second rail extending between the second support member and the fourth support member, and a tool support member having a first end slidably coupled to the first rail and having a second end slidably coupled to the second rail.
Example 2 includes the tool-support apparatus of Example 1, further including a first crossbar extending between the first support member and the third support member, the first rail located along the first crossbar, and a second crossbar extending between the second support member and the fourth support member, the second rail located along the second crossbar.
Example 3 includes the tool-support apparatus of Example 1, further including a first carriage slidably coupled to the first rail, and a second carriage slidably coupled to the second rail, the first end of the tool support member coupled to the first carriage, the second end of the tool support member coupled to the second carriage.
Example 4 includes the tool-support apparatus of Example 1, including a first locator pin at the first end of the tool support member, and a second locator pin at the second end of the tool support member.
Example 5 includes the tool-support apparatus of Example 1, wherein the tool support member is to move along the first rail and the second rail towards the first and second host-mating plates and away from the first and second host-mating plates.
Example 6 includes the tool-support apparatus of Example 1, wherein the first stabilizer includes a first collet assembly, and a first elongated member retractably extendable through the first collet assembly towards a surface supporting the tool-support apparatus, and the second stabilizer includes a second collet assembly, and a second elongated member retractably extendable through the second collet assembly towards the surface supporting the tool-support apparatus.
Example 7 includes the tool-support apparatus of Example 1, including at least one positioning pin extending from the first host-mating plate.
Example 8 includes a tool-support apparatus comprising a frame, a first stabilizer affixed to a first portion of the frame, a second stabilizer affixed to a second portion of the frame, the second portion opposite the first portion, first and second rails extending between a front side of the frame and a rear side of the frame, a first locator pin slidably coupled to the first rail, and a second locator pin slidably coupled to the second rail.
Example 9 includes the tool-support apparatus of Example 8, wherein the first locator pin is to align with an alignment reference structure of a host assembly.
Example 10 includes the tool-support apparatus of Example 8, further including a host-mating plate affixed to the front side of the frame.
Example 11 includes the tool-support apparatus of Example 10, further including at least one positioning pin extending from the host-mating plate, the positioning pin is to be received in a positioning aperture of a host assembly.
Example 12 includes the tool-support apparatus of Example 8, further including a host-mating anchor affixed to the front side of the frame, the host-mating anchor to be received at a receiver structure of a host assembly.
Example 13 includes the tool-support apparatus of Example 8, further including a tool support member having a first end slidably coupled to the first rail and having a second end slidably coupled to the second rail.
Example 14 includes the tool-support apparatus of Example 13, wherein the tool support member is to receive a tool and slidably move the tool towards and away from the front side of the frame.
Example 15 includes a manufacturing system comprising a frame including a host interface coupled to the frame, and first and second rails extending between a front of the frame and a rear of the frame, a host assembly including a receiver to engage the host interface of the frame, and a tool to be removably coupled to the first and second rails, the tool to move along the first and second rails towards and away from the host assembly.
Example 16 includes the manufacturing system of Example 15, further comprising a first collet assembly coupled to the frame and a first elongated member retractably extendable through the first collet assembly towards a surface, and a second collet assembly coupled to the frame and a second elongated member retractably extendable through the second collet assembly towards the surface.
Example 17 includes the manufacturing system of Example 15, wherein the host interface includes at least one pin extending from the host interface, the pin to be received in an aperture of the receiver.
Example 18 includes the manufacturing system of Example 15, wherein the host interface includes an anchor, the anchor to be received in the receiver of the host assembly.
Example 19 includes the manufacturing system of Example 15, wherein the tool is a hoist to move an object to and from the host assembly.
Example 20 includes the manufacturing system of Example 15, wherein the host assembly includes an alignment reference structure, the frame including a tool support having a first end slidably coupled to the first rail and having a second end slidably coupled to the second rail, and a pin to align with the alignment reference structure of the host assembly.
Example 21 includes a method comprising re-locating a mobile tool-support apparatus to a location of an assembly jig in a manufacturing environment, removably coupling the mobile tool-support apparatus to the assembly jig via a host interface of the mobile tool-support apparatus and a receiver of the assembly jig, removably coupling a tool to the mobile tool-support apparatus, and moving the tool towards and away from the assembly jig along rails of the mobile tool-support apparatus.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A tool-support apparatus comprising:
a frame having a first support member, a second support member, a third support member, and a fourth support member;
a first host-mating plate affixed to the first support member;
a second host-mating plate affixed to the second support member;
a first stabilizer affixed to the third support member;
a second stabilizer affixed to the fourth support member;
a first rail extending between the first support member and the third support member;
a second rail extending between the second support member and the fourth support member; and
a tool support member having a first end slidably coupled to the first rail and having a second end slidably coupled to the second rail.

2. The tool-support apparatus of claim 1, further including:
a first crossbar extending between the first support member and the third support member, the first rail located along the first crossbar; and
a second crossbar extending between the second support member and the fourth support member, the second rail located along the second crossbar.

3. The tool-support apparatus of claim 1, further including:
a first carriage slidably coupled to the first rail; and
a second carriage slidably coupled to the second rail, the first end of the tool support member coupled to the first carriage, the second end of the tool support member coupled to the second carriage.

4. The tool-support apparatus of claim 1, including:
a first locator pin at the first end of the tool support member; and
a second locator pin at the second end of the tool support member.

5. The tool-support apparatus of claim 1, wherein the tool support member is to move along the first rail and the second rail towards the first and second host-mating plates and away from the first and second host-mating plates.

6. The tool-support apparatus of claim 1, wherein:
the first stabilizer includes:
a first collet assembly; and
a first elongated member retractably extendable through the first collet assembly towards a surface supporting the tool-support apparatus; and
the second stabilizer includes:
a second collet assembly; and
a second elongated member retractably extendable through the second collet assembly towards the surface supporting the tool-support apparatus.

7. The tool-support apparatus of claim 1, including at least one positioning pin extending from the first host-mating plate.

8. A tool-support apparatus comprising:
a frame;
a first stabilizer affixed to a first portion of the frame;
a second stabilizer affixed to a second portion of the frame, the second portion opposite the first portion;
first and second rails extending between a front side of the frame and a rear side of the frame;
a first locator pin slidably coupled to the first rail; and
a second locator pin slidably coupled to the second rail.

9. The tool-support apparatus of claim 8, wherein the first locator pin is to align with an alignment reference structure of a host assembly.

10. The tool-support apparatus of claim 8, further including a host-mating plate affixed to the front side of the frame.

11. The tool-support apparatus of claim 10, further including at least one positioning pin extending from the host-mating plate, the positioning pin is to be received in a positioning aperture of a host assembly.

12. The tool-support apparatus of claim 8, further including a host-mating anchor affixed to the front side of the frame, the host-mating anchor to be received at a receiver structure of a host assembly.

13. The tool-support apparatus of claim 8, further including a tool support member having a first end slidably coupled to the first rail and having a second end slidably coupled to the second rail.

14. The tool-support apparatus of claim 13, wherein the tool support member is to receive a tool and slidably move the tool towards and away from the front side of the frame.

15. A manufacturing system comprising:
a frame including:
a host interface coupled to the frame; and
first and second rails extending between a front of the frame and a rear of the frame;
a host assembly including a receiver to engage the host interface of the frame; and
a tool to be removably coupled to the first and second rails, the tool to move along the first and second rails towards and away from the host assembly.

16. The manufacturing system of claim 15, further comprising:
a first collet assembly coupled to the frame and a first elongated member retractably extendable through the first collet assembly towards a surface; and
a second collet assembly coupled to the frame and a second elongated member retractably extendable through the second collet assembly towards the surface.

17. The manufacturing system of claim 15, wherein the host interface includes at least one pin extending from the host interface, the pin to be received in an aperture of the receiver.

18. The manufacturing system of claim 15, wherein the host interface includes an anchor, the anchor to be received in the receiver of the host assembly.

19. The manufacturing system of claim 15, wherein the tool is a hoist to move an object to and from the host assembly.

20. The manufacturing system of claim 15, wherein the host assembly includes an alignment reference structure, the frame including:
a tool support having a first end slidably coupled to the first rail and having a second end slidably coupled to the second rail; and
a pin to align with the alignment reference structure of the host assembly.

21. A method comprising:
re-locating a mobile tool-support apparatus to a location of an assembly jig in a manufacturing environment;
removably coupling the mobile tool-support apparatus to the assembly jig via a host interface of the mobile tool-support apparatus and a receiver of the assembly jig;
removably coupling a tool to the mobile tool-support apparatus; and
moving the tool towards and away from the assembly jig along rails of the mobile tool-support apparatus.
